(19) United States
(12) Patent Application Publication
(10) Pub. No.: US 2024/0040161 A1
(43) Pub. Date: Feb. 1, 2024

(54) METHOD AND SERVER FOR HANDLING STREAMING DATA

(71) Applicant: 17LIVE Japan Inc., Tokyo (JP)

(72) Inventors: Yu-Chuan CHANG, Taipei City (TW); Kun-Ze LI, Taipei City (TW); Che-Wei LIU, Taipei City (TW)

(21) Appl. No.: 18/320,830

(22) Filed: May 19, 2023

(30) Foreign Application Priority Data
Jul. 30, 2022 (JP) 2022-122362

(51) Int. Cl. H04N 21/2187; H04N 21/433

(52) U.S. Cl. CPC H04N 21/2187; H04N 21/4334

(57) ABSTRACT

The subject application relates to a method and system for handling streaming data for a live streaming, and includes recording the streaming data for the live streaming; storing the streaming data as archive contents; and adding a transition segment in the archive contents. According to the subject application, the time for processing the archive contents is saved and the user experience may be enhanced.

### CROSS-REFERENCE TO RELATED APPLICATIONS

This application is based on and claims the benefit of priority from Japanese Patent Application Serial No. 2022-122362 (filed on Jul. 30, 2022), the contents of which are hereby incorporated by reference in its entirety.

### TECHNICAL FIELD

This disclosure relates to information and communication technology, and in particular, to a system and a method for handling streaming data for a live streaming.

### BACKGROUND

Some APPs or platforms provide archive service for streamers to record their live streaming (For example, see non-patent document 1 and 2). The streamers may record their best moments to replay or share with their fans for fun. The viewer may also record the live streaming to recheck the live streaming afterward if they are not available during the live streaming.

The archive services mainly provide archive contents for the streamers or viewers to enjoy the performance from the streamers offline. However, the archive contents may be used in a variety of ways to create more value. Therefore, a more efficient and useful archive service is on demand
[Non-Patent Document 1]: https://support.google.com/youtube/answer/6247592?hl=en
[Non-Patent Document 2]: https://help.twitch.tv/s/article/video-on-demandlanguage=en_US

### SUMMARY

An embodiment of subject application relates to a method for handling streaming data for a live streaming, comprising recording the streaming data for the live streaming; storing the streaming data as archive contents; and adding a transition segment in the archive contents.

Another embodiment of subject application relates to a system for handling streaming data for a live streaming, comprising one or a plurality of processors, wherein the one or plurality of processors execute a machine-readable instruction to perform: recording the streaming data for the live streaming; storing the streaming data as archive contents; and adding a transition segment in the archive contents.

Another embodiment of subject application relates to a non-transitory computer-readable medium including program instructions, that when executed by one or more processors, cause the one or more processors to execute: recording the streaming data for the live streaming; storing the streaming data as archive contents; and adding a transition segment in the archive contents.

The present disclosure may archive the live streaming and add a transition segment in the archive contents, and the transition segments may include information for reference. Therefore, the time for processing the archive contents is saved and the user experience may be enhanced.

### BRIEF DESCRIPTION OF THE DRAWINGS

FIG. 1 is a schematic configuration of a live streaming system 1 according to some embodiments of subject application;

FIG. 2 is a schematic block diagram of the user terminal 20 according to some embodiments of subject application;

FIG. 3 is a schematic block diagram of the server 10 according to some embodiments of subject application;

FIG. 4 shows an exemplary data structure of the stream DB 320 of FIG. 3;

FIG. 5 shows an exemplary data structure of the archive DB 32.2 of FIG. 3;

FIG. 6 shows an exemplary data structure of the transition DB 324 of FIG. 3;

FIG. 7 shows an exemplary data structure of the AD DB 326 of FIG. 3;

FIG. 8-FIG. 12 depicts a serve for providing an archived streaming data for live streaming according to some embodiments of subject application;

FIG. 13 is exemplary screens of the transition segment according to some embodiments of subject application;

FIG. 14 is a diagram illustrating example operation of the transition unit 312 according to some embodiments of subject application;

FIG. 15-FIG. 17 is an exemplary sequence chart illustrating an operation of the configuration of the archive service according to some embodiments of subject application;

FIG. 18 is an exemplary hardware configuration of the information processing device according to some embodiments of subject application.

### DETAILED DESCRIPTION

Hereinafter, the identical or similar components, members, procedures or signals shown in each drawing are referred to with like numerals in all the drawings, and thereby an overlapping description is appropriately omitted. Additionally, a portion of a member which is not important in the explanation of each drawing is omitted.

The live streaming system 1 according to some embodiments of subject application provides enhancement among the users to communicate and interact smoothly. More specifically, it entertains the viewers and streamers in a technical way.

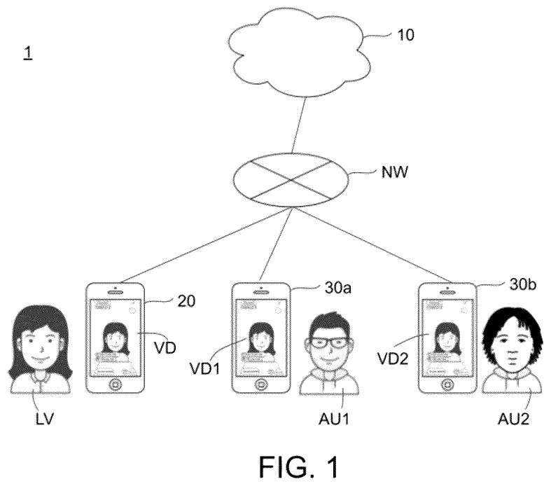

FIG. 1 shows a schematic configuration of a live streaming system 1 according to some embodiments of subject application. The live streaming system 1 provides a live streaming service for the streaming distributor (may also be referred as live or streamer) LV and viewer (may also be referred as audience) AU (AU1, AU2 . . . ) to interact mutually in real time. As shown in FIG. 1, the live streaming system 1 may include a server 10, a user terminal and a user terminal 30(30a, 30b . . . ). The user terminal 20 may be a streamer and the user terminal 30 may be a viewer. In some embodiments, the streamers and viewers may be referred to as the user. The server 10 may include one or a plurality of information processing devices connected via network NW. The user terminal 20 and 30 may be, for example, a portable terminal such as the smartphone, tablet, laptop PC, recorder, mobile game console, wearable device or the like, or the stationary computer such as desktop PC. The server 10, user terminal and user terminal 30 may be communicably connected by any type of wire or wireless network NW.

The live streaming system 1 is involved in the streamer LV, the viewer AU, and APP provider (not shown), who provides the server 10. The streamer LV may record his/her own contents such as songs, talks, performance, game streaming or the like by his/her own user terminal 20 and upload to the server 10, and be the one who distributes contents in real time. In some embodiments, the streamer LV may interact with the viewer AU via the live streaming.

The APP provider may provide a platform for the contents to go on live streaming in the server 10. In some embodiments, the APP provider may be the media or manager to manage the real time communication between the streamer LV and viewer AU. The viewer AU may access the platform by the user terminal 30 to select and watch the contents he/she would like to watch. The viewer AU may perform operations such as commenting or cheering the streamer by the user terminal 30. The streamer, who provides the contents, may respond to the comment or cheer. The response of the streamer may be transmitted to the viewer AU by video and/or audio or the like. Therefore, a mutual communication among the streamer and viewer may be accomplished.

The “live streaming” in this specification may be referred to as the data transmission which enables the contents the streamer LV recorded by the user terminal 20 to be substantially reproduced and watched by the viewer AU via the user terminal 30, In some embodiments, the “live streaming” may also refer to the streaming which is accomplished by the above data transmission. The live streaming may be accomplished by the well-known live streaming technology such as HTTP Live Streaming, Common Media Application Format, Web Real-Time Communications, Real-Time Messaging Protocol, MPEG DASH or the like. The live streaming may further include the embodiment that the viewer Ali may reproduce or watch the contents with specific delay while the streamer is recording the contents. Regarding the magnitude of the delay, it should be at least small enough to enable the streamer LV and the viewer AU to communicate. However, live streaming is different from so-called on-demand streaming. More specifically, the on-demand streaming may be referred to as storing all data, which records the contents, in the server and then providing the data from the server to the user at random timing according to the user's request.

The “streaming data” in this specification may be referred to as the data includes image data or voice data. More specifically, the image data (may be referred to as video data) may be generated by the image pickup feature of the user terminal 20 and 30. The voice data (may be referred to as audio data) may be generated by the audio input feature of the user terminal 20 and 30. The streaming data may be reproduced by the user terminal 20 30, so that the contents relating to users may be available for watching. In some embodiments, during the period from the streaming data being generated by the user terminal of the streamer to being reproduced by the user terminal of the viewer, the processing of changing format, size or specification of the data, such as compression, extension, encoding, decoding, transcoding or the like, is predictable. Before and after this kind of processing, the contents (such as video and audio) is substantially unchanged, so it is described in the current embodiments of the present disclosure that the streaming data before being processed is the same as that after being processed. In other words, if the streaming data is generated by the user terminal of the streamer and reproduced by the user terminal of the viewer via the server 10, the streaming data generated by the user terminal of the streamer, the streaming data passed through the server 10 and the streaming data received and reproduced by the by the user terminal of the viewer are all the same streaming data.

As shown in FIG. 1, the streamer LV is providing the live streaming. The user terminal 20 of the streamer generates the streaming data by recording his/her video and/or audio, and transmits to the server 10 via the network NW. At the same time, the user terminal 20 may display the video VD on the display of the user terminal 20 to check the streaming contents of the streamer LV.

The viewer AU1, AU2 of the user terminal 30a, 30b, who request the platform to provide the live streaming of the streamer, may receive streaming data corresponding to the live streaming via the network NW and reproduce the received streaming data to display the video VD1, VD2 on the display and output the audio from a speaker or the like. The video VD1, VD2 displayed on the user terminal 30a, 30b respectively may be substantially the same as the video VD recorded by the user terminal of the streamer LV, and the audio outputted from the terminal 30a, 30b may also be substantially the same as the audio recorded by the user terminal of the streamer LV.

The recording at the user terminal 20 of the streamer may be simultaneous with the reproducing of the streaming data at the user terminal 30a, 30h of the viewer AUL AU2. If a viewer AU1 inputs a comment on the contents of the streamer LV into the user terminal 30a, the server 10 will display the comment on the user terminal 20 of the streamer in real time, and also display on the user terminal 30a, 30b of the viewer AU1, AU2 respectively. If the streamer LV responds to the comment, the response may be outputted as the text, image, video or audio from the terminal 30a, 30b of the viewer AU1, AU2, so that the communication of the streamer LV and viewer LV may be realized. Therefore, the live streaming system may realize the live streaming of two-way communication.

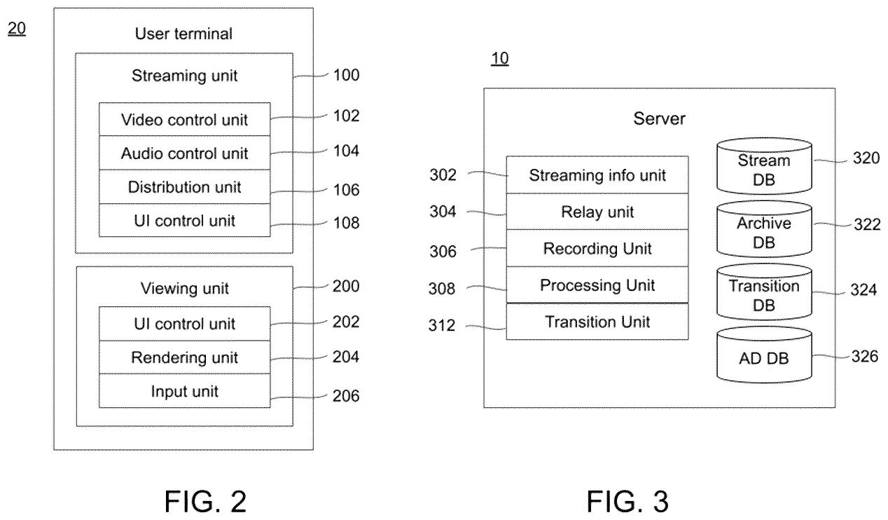

FIG. 2 is a block diagram showing a function and configuration of the user terminal 20 in FIG. 1 according to the embodiment of the present disclosure. The user terminal has the similar function and configuration of the user terminal 20. The blocks depicted in the block diagram of this specification are implemented in hardware such as devices like a CPU of a computer or mechanical components, and in software such as a computer program depicts functional blocks implemented by the cooperation of these elements. Therefore, it will be understood by those skilled in the art that the functional blocks may be implemented in a variety of manners by a combination of hardware and software.

The streamer LV and viewer AU may download and install the live streaming application (live streaming APP) of the present disclosure to the user terminal 20 and 30 from the download site via network NW. Or the live streaming APP may be pre-installed in the user terminal 20 and 30. By the execution of the live streaming by the user terminal 20 and 30, the user terminals 20 and 30 may communicate with the server 10 via the network NW to realize a plurality of functions. The functions realized by the execution of the live streaming APP by the user terminal 20 and 30 (More specifically, the processor such as CPU) is described below as the functions of the user terminal 20 and 30. These functions are basically the functions that the live streaming APP makes the user terminals 20 and 30 realize. In some embodiments, these functions may also be realized by transmitting from the server 10 to the web browser of the user terminal 20 and 30 via network NW and be executed by the computer program of the web browser. The computer program may be written in the programming language such as HTML (Hyper Text Markup Language) or the like.

The user terminal 20 includes streaming unit 100 and viewing unit 200. In some embodiments, the streaming unit 100 is configured to record the audio and/or video data of the user and generate streaming data to transmit to the server 10, The viewing unit 200 is configured to receive and reproduce streaming data from server 10. In some embodiments, a user may activate the streaming unit 100 when broadcasting or activate the viewing unit 200 when watching streaming respectively. In some embodiments, the user terminal who is activating the streaming unit 100 may be referred to as an streamer or be referred to as the user terminal which generates the streaming data. The user terminal who is activating the viewing unit 200 may be referred to as an viewer or be referred to as the user terminal which reproduces the streaming data.

The streaming unit 100 may include video control unit 102, audio control unit 104, distribution unit 106 and UI control unit 108. The video control unit 102 may be connected to a camera (not shown) and the video is controlled by the camera. The video control unit 102 may obtain the video data from the camera. The audio control unit 104 may be connected to a microphone (not shown) and the audio is controlled by the microphone. The audio control unit 104 may obtain the audio data from the microphone.

The distribution unit 106 receives streaming data, which includes video data from the video control unit 10:2 and audio data from the audio control unit 104, and transmits to the server 10 via network NW. In some embodiments, the distribution unit 106 transmits the streaming data in real-time. In other words, the generation of the streaming data from the video control unit 102 and audio control unit 104, and the distribution of the distribution unit 106 is performed simultaneously.

UI control unit 108 controls the UI for the streamer. The UI control unit 108 is connected to a display (not shown) and is configured to generate the streaming data to whom the distribution unit 106 transmits, reproduces and displays the streaming data on the display. The UI control unit 108 shows the object for operating or the object for instruction-receiving on the display and is configured to receive the tap input from the streamer.

The viewing unit 200 may include UI control unit 202, rendering unit 204 and input unit 206. The viewing unit 200 is configured to receive streaming data from server 10 via network NW. The UI control unit 202 controls the UI for the viewer. The UI control unit 202 is connected to a display (not shown) and/or speaker (not shown) and is configured to display the video on the display and output the audio from the speaker by reproducing the streaming data. In some embodiments, Outputting the video on the display and audio from the speaker may be referred to as “reproducing the streaming data”.

The UI control unit 202 may be connected to an input unit such as touch panel, keyboard or display or the like to obtain input from the users. The rendering unit 204 may be configured to render the streaming data from the server 10 and the frame image. The frame image may include user interface objects for receiving input from the user, the comments inputted by the viewers and the data received from the server 10. The input unit 206 is configured to receive the user input from the UI control unit 202 and transmit to the server 10 via the network NW.

FIG. 3 is a schematic block diagram of the server 10 according to some embodiments of the subject application. The server 10 may include streaming info unit 302, relay unit 304, recording unit 306, processing unit 308, transition unit 312, stream DB 320, archive DB 322, transition DB 324 and AD DB 326.

The streaming info unit 302 receives the request of live streaming from the user terminal 20 of the streamer via the network NW. Once receiving the request, the streaming info unit 302 registers the information of the live streaming on the stream DB 320. In some embodiments, the information of the live streaming may be the stream ID of the live streaming and/or the streamer ID of the streamer corresponding to the live streaming.

Once receiving the request of providing the information of the live streaming from the viewing unit 200 of the user terminal 30 from the viewer via the network NW, the streaming info unit 302 refers to the stream DB 320 and generates a list of the available live streaming.

The streaming info unit 302 then transmits the list to the user terminal 30 via the network NW. The UI control unit 202 of the user terminal 30 generates a live streaming selection screen according to the list and displays the list on the display of the user terminal 30.

Once the input unit 206 of the user terminal 30 receives the selection of the live streaming from the viewer on the live streaming selection screen, it generates the streaming request including the stream ID of the selected live streaming and transmits to the server 10 via the network. The streaming info unit 302 may start to provide the live streaming, which is specified by the stream ID in the streaming request, to the user terminal 30. The streaming info unit 302 may update the stream DB 320 to add the viewer's viewer ID of the user terminal 30 to the streamer ID of the stream ID.

The relay unit 304 may relay the transmission of the live streaming from the user terminal 20 of the streamer to the user terminal 30 of the viewer in the live streaming started by the streaming info unit 302. The relay unit 304 may receive the signal, which indicates the user input from the viewer, from the input unit 206 while the streaming data is reproducing. The signal indicating the user input may be the object-designated signal which indicates the designation of the object shown on the display of the user terminal 30. The object-designated signal may include the viewer ID of the viewer, the streamer ID of the streamer, who delivers the live streaming the viewer is viewing, and object ID specified by the object. If the object is a gift or the like, the object ID may be the gift ID or the like. Similarly, the relay unit 304 may receive the signal indicating the user input of the streamer, for example the object-designated signal, from the streaming unit 100 of the user terminal 20 while the streaming data is reproducing.

The recording unit 306 may be configured to record the live streaming. In some embodiments, the recording unit 306 may record the live streaming automatically or manually according to the setting by the user terminal 20 of the streamer. For example, the streamer may turn on an auto-archive toggle before starting live streaming in order to record and archive the live streaming automatically. The recording unit 306 may start recording the live streaming when the streamer starts streaming and stop recording once the live streaming is ended. In some embodiments, the streamer or the viewer may clip the live streaming manually during the live streaming.

In some embodiments, the recording unit 306 may record the live streaming with a maximum duration of the archive contents, such as eight hours or the like. For example, the recording unit 306 may record the live streaming with a duration up to eight hours or the like. If the live streaming continues for less than eight hours, the recording unit 306 may record and archive the live streaming. However, if the live streaming is longer than eight hours, the recording unit 306 may record the live streaming for eight hours and start another recording for the next eight hours or less.

In some embodiments, the recording unit 306 may store the archive contents of the live streaming in storage such as Goode Cloud and register the data of the archive contents in the archive DB 322 for reference and further processing. In some embodiments, any possible transmission protocol such as HTTP live streaming (HLS) may be applied among the server and user terminals. In some embodiments, the recording unit 306 may receive live streaming from a streaming source and record the live streaming as archive contents.

During a live streaming communication, different transmission protocols may be used. Here, HTTP live streaming (HLS) is taken as an example for explanation. HTTP live streaming (HLS) is an HTTP-based streaming media network transmission protocol which is proposed by Apple Inc. The HLS is formed by M3U8 segment index files and transport stream (TS) segments.

The M3U8 file may be referred to as an index file of a ts segment, and may be used for storing download addresses of ts segments in a server. An user terminal can read the ts segments in turn according to the M3U8 file. A ts segment may be referred to as a video clip obtained by dividing an entire video file or a video stream.

The HLS may divide an entire audio and video stream into small HTTP-based files for downloading, and only a portion of the files may be downloaded each time. When a media stream is playing, viewers may select to download the same resource at different rates from many different alternate sources, and allow a streaming media session to adapt to different data rates.

Different streaming sources may provide different formats of the streaming data such as FLV or M3U8. The recording unit 306 may receive streaming data from the streaming sources and convert the format of the streaming data into any kind of format for processing. The recording unit 306 may record and store the archive contents as any possible format of streaming data. Here, the M3U8 playlist with the ts segments is taken as an example for explanation. The recording unit 306 may record the streaming data for the live streaming as the ts segments for the processing unit 308 to check and store in a storage.

The processing unit 308 may be configured to process the archive contents. In some embodiments, the processing unit 308 may store the archive contents as transport stream (TS) segments. The processing unit 308 may further generate a M3U8 playback list for the TS segments. In some embodiments, the processing unit 308 may keep the archive contents in the storage and database for a specific period such as 7 days, 14 days or the like. Therefore, the memory may be used efficiently.

In some embodiments, the processing unit 308 may provide the user terminal 30 of the viewer with the archive contents when the live streaming is inaccessible. Here, the inaccessible may be referred to as the live streaming is ended or the live streaming is not capable of being pulled by the viewer. For example, the viewer may find out one interesting live streaming or receive a push notification of a live streaming. If the viewer does not click the live streaming or push notification right away, there is a possibility that the live streaming has ended when accessing the live streaming. If so, the viewer may feel disappointed and can do nothing but leave. In this situation, the processing unit 308 may provide the user terminal 30 of the viewer with the archive contents. In some embodiments, the processing unit 308 may provide with the archive contents when the live streaming is inaccessible such as during an outage or the like.

In some embodiments, the processing unit 308 may detect segments that are not appropriate for recording in the live streaming. More specifically, the live streaming may include some segments that are not appropriate for recording. For example, during a multiple user interaction mode such as group call or PK mode, it may not be able to record due to technical or personal reasons. More specifically, the APP or the platform may not support recording in a multiple user interaction mode, or the other streamers would not like to appear in the archive contents. For another example, the live streaming may include some specific information that is not appropriate for recording such as personal information (name, address or the like) or some inappropriate contents.

In some embodiments, the processing unit 308 may remove the portion including specific information in the archive contents. For example, the recording unit 306 may record the entire live streaming and the processing unit 308 may detect portions including specific information and remove them out of the archive contents. The recording unit 306 may record the live streaming without the specific information and stop recording when specific information is detected. Furthermore, the processing unit 308 may further combine a plurality of archive contents as one archive contents. Therefore, the archive contents may be easy to watch and the user experience may be enhanced.

In some embodiments, the processing unit 308 may add a transition segment in the archive contents. In some embodiments, the processing unit 308 may insert a transition segment in the archive contents. In some embodiments, specific information may be included in a portion of the archive contents. In some embodiments, the processing unit 308 may replace the portion of the archive contents with the transition segment. In some embodiments, the processing unit 308 may add the transition segment upon the portion of the archive contents. In some embodiments, the processing unit 308 may perform a process on the portion of the archive contents to cover the specific information.

In some embodiments, the transition segment may include text, image, video or audio or the like. In some embodiments, the transition segment may include the information related to the archive contents before or after the transition segment. For example, if the streamer is talking about a car, the transition segment may include information such as advertisements of the car. If the streamer is going to have a performance, the transition segment may include the information of the introduction of the upcoming performance. In some embodiments, the transition segment may include the information related to the archive contents during the transition segment. More specifically, if a portion of the archive contents includes multiple user interaction such as group call or PK mode, the portion of the multiple user interaction may be replaced with a transition segment, and the transition segment may include the information about the portion, such as “group call or PK is on-going” or the like. In some embodiments, the transition segment may include any kind of information to notify the viewer that there is an intermittent or discontinuity in the archive contents. For example, the transition segment may include information such as “a few moments later”, “this portion is omitted” or other related phrases. In some embodiments, the transition segment may include other information such as recommended streamers, advertisements, sales, news, questionnaires or the like. In some embodiments, the transition segment may include information of the streamer such as the introduction of the streamer, live streaming schedule of the streamer or the like.

In some embodiments, the duration of the transition segment may be determined flexibly. For example, the duration of the transition segment may be around the range that is long enough for the viewer to catch the information on the transition segment and short enough for the viewer not to feel dislike about the transition segment. In some embodiments, the duration of the transition segment may be a specific duration of 3, 5, 10, 15, 30, 60 second or more. In some embodiments, if a transition segment replaces a portion of the archive contents, the duration of the transition segment may be the same as the duration of the portion of the archive contents. For example, if a portion of the archive contents includes group call or PK mode and the portion is replaced with a transition segment, the duration of the transition segment may be the same as the duration of the group call or PK mode. Therefore, the viewer may understand the timeline of the live streaming and the user experience is enhanced. In some embodiments, the duration of the transition segment may be shorter than the portion of the archive contents, such as five seconds or the like. Therefore, the viewer may not be disturbed by the transition segment. In some embodiments, the transition segment may include an UI object button for the viewer to skip the transition segment. Therefore, the viewer may be able to choose to watch or not watch the transition segment, and the user experience may be enhanced.

In some embodiments, the processing unit 308 may add transition segments in the archive contents at each specific time intervals. For example, the transition segments may be added each one hour or the like. According to the embodiments, the transition segments may be a reminder to notify the viewer how long the archive contents is watched or to notify the viewer to take a rest or the like.

In some embodiments, the processing unit 308 may add transition segments in the archive contents before an event happens or after an event ends. For example, the processing unit 308 may detect special moments in the archive contents such as a performance from the streamer, and the processing unit 308 may add a transition segment before the special moments to indicate a special moment is coming and make the viewer wait for the special moments. For another example, the processing unit 308 may detect a lucky draw event from the streamer, and processing unit 308 may add a transition segment after the event to review or conclude the result of the lucky draw for reference.

In some embodiments, the processing unit 308 may add a transition segment upon a portion of the archive contents. In some embodiments, the transition segment may include authentication information such as identity authentication, password input or the like. For example, the portion including specific information may be for adult, VIP viewers or followers only, and a transition segment may be added upon the portion, so the viewers may need to finish the authentication in order to get access to the portion. In some embodiments, the transition segment may include payment information for the viewer to pay to get access to the portion. In some embodiments, the processing unit 308 may add a set of transition segments right before and after the portion to lock the portion.

The transition unit 312 may be configured to generate transition segments. In some embodiments, the transition segments may be provided manually or automatically. In some embodiments, the contents of the transition segment may also be added manually or automatically. In some embodiments, the transition segment may also be provided by streamers, viewers or the like. In some embodiments, the transition segments may be provided in advance or in real-time. In some embodiments, machine learning technology may be applied for making the transition segment. For example, a machine learning mode may be trained and used to detect the contents of the live streaming and match with suitable contents in the transition segments.

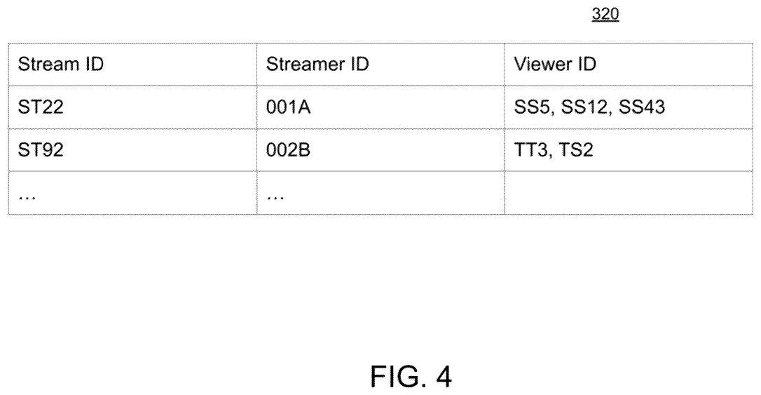

FIG. 4 shows an exemplary data structure of the stream DB 320 of FIG. 3. The stream DB 320 associatively stores the stream ID identifying a live streaming, the streamer ID identifying the streamer conducting the respective live streaming, the viewer ID identifying the viewer viewing the respective live streaming.

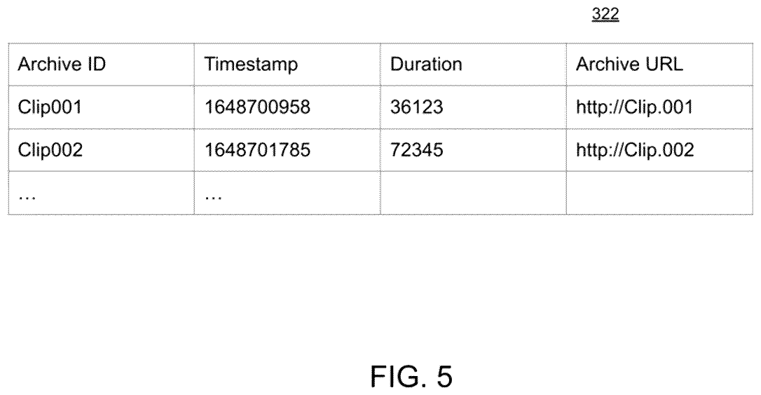

FIG. 5 shows an exemplary data structure of the archive DB 322 of FIG. 3. The archive DB 322 associatively stores the archive ID identifying an archive contents, the timestamp identifying the time of the archive contents, the duration identifying the duration of the archive contents, the archive URL identifying the location of the archive contents.

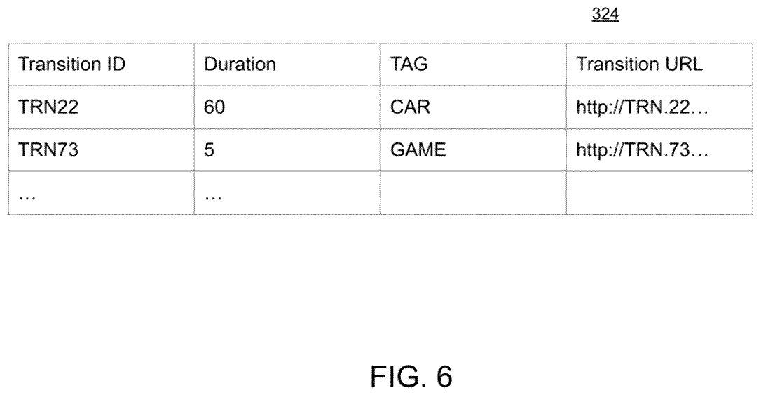

FIG. 6 shows an exemplary data structure of the transition DB 324 of FIG. 3. The transition DB 324 associatively stores the transition ID identifying a transition segment, the duration identifying the duration of the transition segment, the tag identifying the genre and information of the transition segment, the transition URL identifying the location of the transition segment.

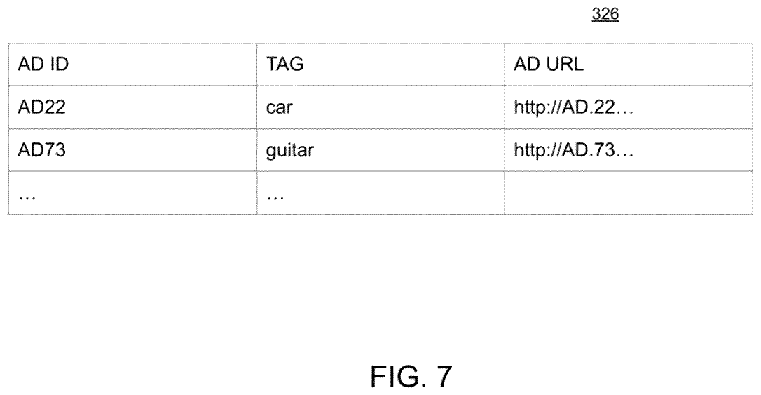

FIG. 7 shows an exemplary data structure of the AD DB 326 of FIG. 3. The AD DB 326 associatively stores the AD ID identifying an advertisement, the tag identifying the genre and information of the advertisement, the AD URL identifying the location of the AD. In some embodiments, the stream DB 320, archive DB 322, transition DB 324 and AD DB 326 may include other necessary data for the archive service.

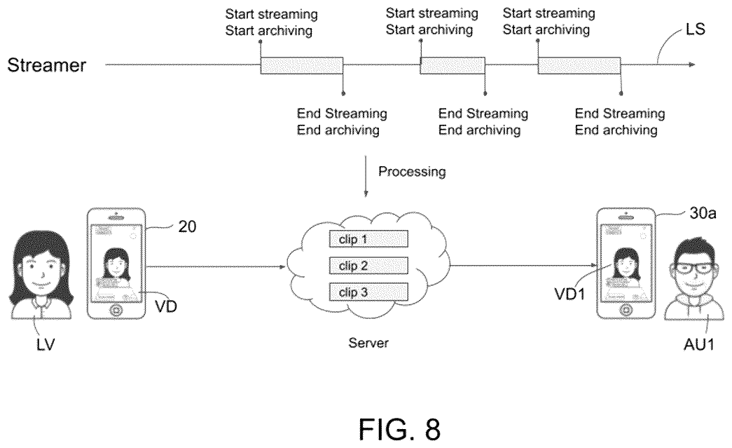

FIG. 8-FIG. 12 depicts a server for providing archived streaming data for live streaming LS according to some embodiments of subject application. As shown in FIG. 8 the user terminal 20 of streamer LV may push the live streaming LS of the video VD to a server such as a streaming server. The streamer LV may start and end live streaming LS for more than once. The recording unit 306 may automatically or manually record the live streaming LS as the archive contents. In some embodiments, if the streamer starts and ends live streaming LS for three times, three archive contents may be archived as clip 1, clip 2 and clip 3. The viewer AU1 of the user terminal 30a of the viewer AU1 may select which clip he or she would like to watch and display the video VD1 on the display.

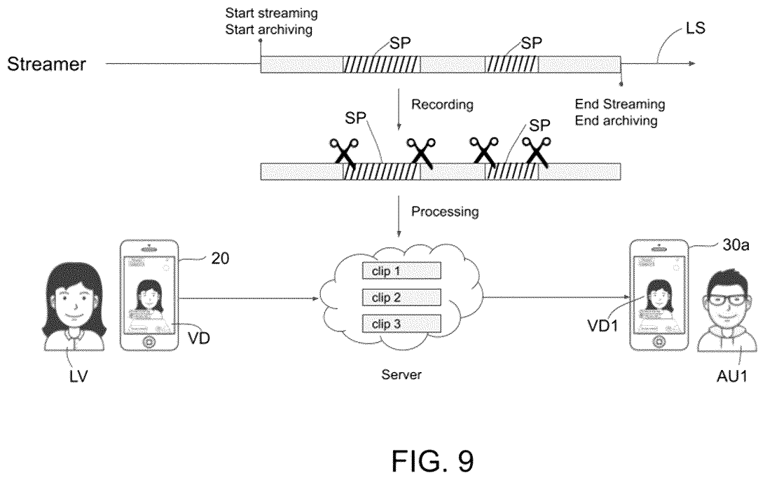

As shown in FIG. 9, the streamer LV of the user terminal 20 may start and end live streaming LS for a period, and the live streaming LS may include some specific portion SP including specific information. In some embodiments, the processing unit 308 may remove the specific portion SP from the archive contents. More specifically, the processing unit 308 may cut the archive contents into pieces and remove the portion including specific portion SP.

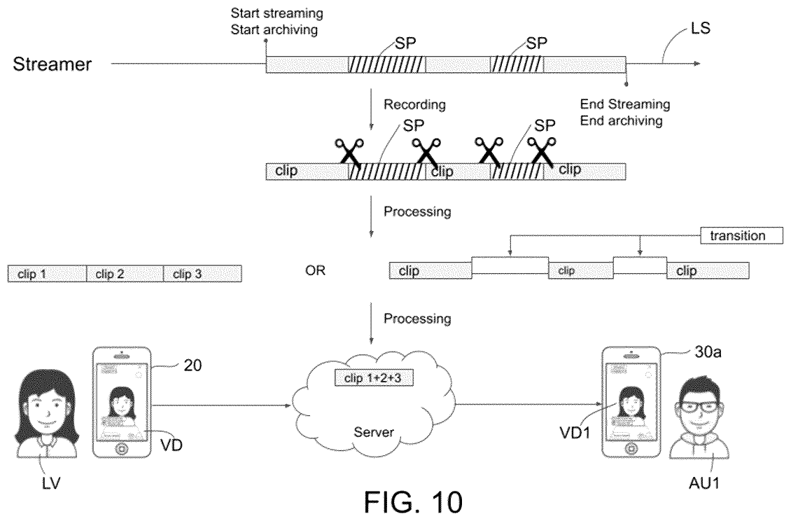

As shown in FIG. 10, the processing unit 308 may further combine the clips from the same live streaming into one clip. Therefore, it makes the viewer AU1 easier to watch and the user experience may be enhanced. In some embodiments the processing unit 308 may add transition segments in the archive contents. For example, a transition segment may be inserted between clips to form a clip.

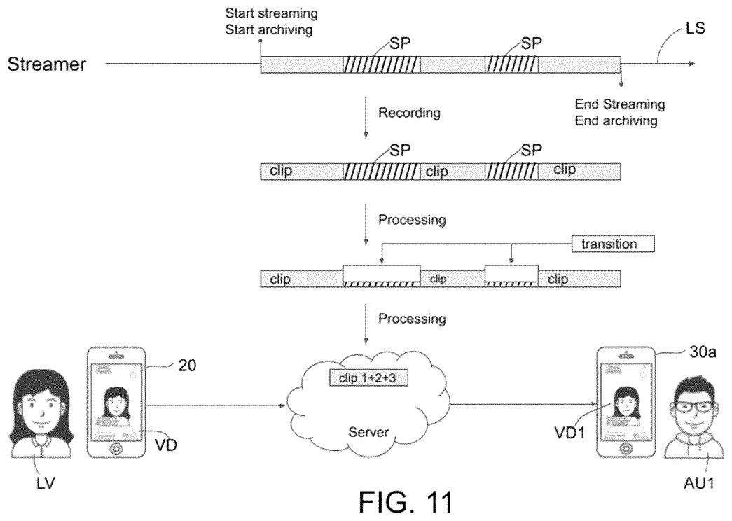

As shown in FIG. 11, the processing unit 308 may replace the specific portion SP with transition segments. In some embodiments, the duration of the transition segment may be the same or shorter than the specific portion SP, or with a specific duration. In some embodiments, the processing unit 308 may add a transition segment upon the specific portion SP to prevent the viewer from watching the specific portion SP.

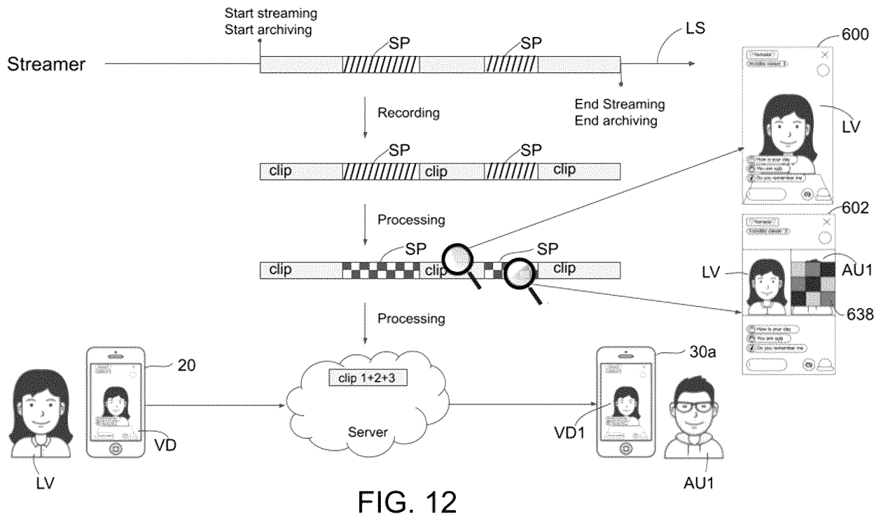

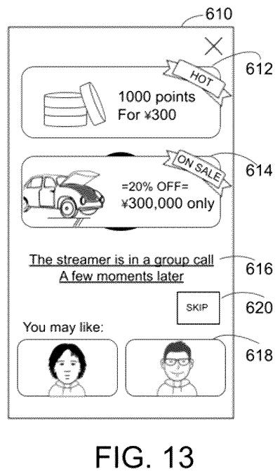

As shown in FIG. 12, the processing unit 308 may perform a process on the specific portion SP of the archive contents. For example, archive contents may include a screen 600 of a streamer LV broadcasting during the live streaming LS. However, a screen 602 of the streamer interacting with a viewer AIR in PK mode or group call may be shown during the specific portion SP. In some embodiments, the video of the other viewer AU1 may not be appropriate to be shown in the archive contents for technical or personal reasons. In some embodiments, the processing unit 308 may perform a process such as adding an transition segment on the specific information of the specific portion SP. For example, the video of the other viewer AU1 may be covered or overlapped by an object 638 such as a mosaic. In some embodiments, a transition segment may also be embedded on the specific information.

FIG. 13 is an exemplary screen 610 of the transition segment according to some embodiments of subject application. In some embodiments, the transition segment may include information 612 related to sales. For example, the sales information 612 may include discount or promotion of in-app points or the like. In some embodiments, the transition segment may include information 614 such as advertisement or the like. In some embodiments, the information 614, such as the advertisement, may be related to the archive contents before or after the transition segment. For example, if the streamer has a conversation about a car, then a transition segment after the conversation may include information such as an advertisement of the car. In some embodiments, the transition segment may include information 616 related to the archive contents during the transition segment. For example, the information 616 may include the information of “the streamer is in a group call” or the like. In some embodiments, the transition segment may include information 618 such as recommendation streamer list or the like. In some embodiments, machine learning technology may also be applied to select the information to be added on the transition segment. In some embodiments, the transition segment may include a button object 620 for the viewer to interact with the transition segment such as skipping the transition segment.

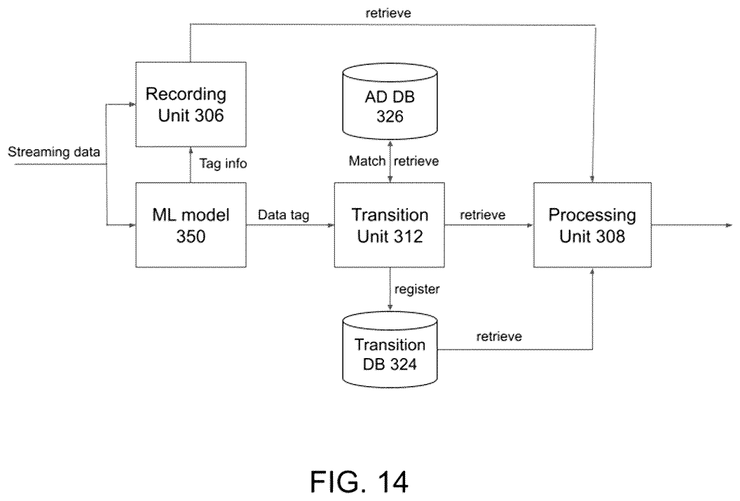

FIG. 14 is a diagram illustrating example operation of the transition unit 312 according to some embodiments of subject application. As shown in FIG. 14, a machine learning model 350 may be applied for making the transition segment. The ML model 350 may be trained to identify the contents of the live streaming. The ML model 350 may receive the live streaming data and identify the contents of the live streaming More specifically, the input of the EVIL model 350 may be the live streaming data and the output of the ML model 350 may be tags of the contents identifying the genre and information of the live streaming. For example, if a female streamer with short hair talks about cars in her streaming, the ML model 350 may output the tag of “female”, “short hair”. “car” or the like. In some embodiments, the ML model 350 may inform the recording unit 306 of the tag information for reference. In some embodiments, the transition unit 312 may provide a transition segment according to the tags of the live streaming. For example, if the transition unit 312 receives a tag of “car” from the ML, model 350, the transition unit 312 may match the live streaming with advertisement in AD DB 326 according to the tags. In some embodiments, the transition unit 312 may add the matched AD in a transition segment. In some embodiments, the transition unit 312 may generate transition segments. The transition segments may be stored in a storage and registered in the transition DB 324. In some embodiments, the transition unit 312 may provide the transition segment in real-time. In other words, the processing unit 308 may retrieve transition segments from the transition unit 312 directly or from the transition DB 324. In some embodiments, the processing unit 308 may add the transition segment in the archive contents of the live streaming and provide the viewer with the archive contents.

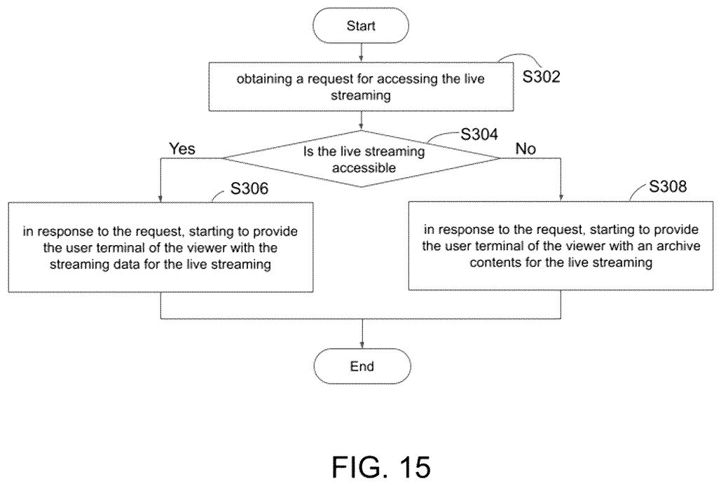

FIG. 15 is an exemplary sequence chart illustrating an operation of the configuration of the archive service according to some embodiments of subject application. In some embodiments, a viewer may get access to an archive contents by clicking on the archive contents. In some embodiments, the viewer may get access to a live stream by clicking on a live stream or clicking on a push notification including information of the live stream. The processing unit 308 may obtain the request for accessing the live streaming (S302). In some embodiments, the processing unit 308 may check if the live streaming is accessible. For example, the live streaming may be inaccessible if the streamer has ended the streaming. In some embodiments, the live streaming may be inaccessible if there is any technical problem.

If the live streaming is accessible (Yes in S304), the processing unit 308 may start to provide the user terminal of the viewer with the streaming data for the live streaming in response to the request. In some embodiments, if the live streaming is inaccessible (No in S304), the processing unit 308 may start to provide the user terminal of the viewer with archive contents for the live streaming in response to the request (S308). Therefore, the viewer may not feel disappointed and may enjoy the archive contents even if the live streaming is ended or inaccessible, so the user experience may be improved.

In some embodiments, the viewers may also share or discover new streamers even if the streamers are offline. Therefore, the retention rate may be enhanced. In some embodiments, the streamer may turn on or off the automatic archive function before starting live streaming. The streamer may also manage the archive contents such as editing image, title, hashtag or the like. The users may also manage the archive contents in their own drive or publish to the public. The duration for each archive contents may be determined and extended flexibly such as eight hours or the like. The expiration date of the archive contents may also be determined and extended flexibly such as seven or fourteen days. In some embodiments, if the archive mechanism does not support some scenario such as group call or pk mode, the screen may show a message to notify the streamer that the recording will stop until back to single mode.

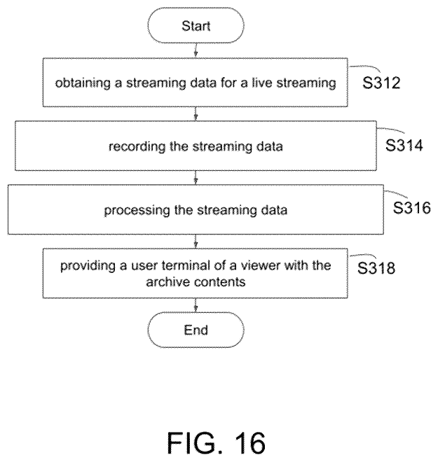

FIG. 16 is an exemplary sequence chart illustrating an operation of the configuration of the archive service according to some embodiments of subject application. In some embodiments, the recording unit 306 may obtain a streaming data for a live streaming (S312). In some embodiments, the recording unit 306 may record the streaming data for the live streaming (S314). In some embodiments, the processing unit 308 may process the archive contents (S316). For example, the processing unit 308 may store the streaming data as archive contents. The processing unit 308 may perform a process such as cut, remove, combine, add a transition segment, image handling or the like. In some embodiments, the processing unit 308 may provide a user terminal of a viewer with the archive contents in response to a request.

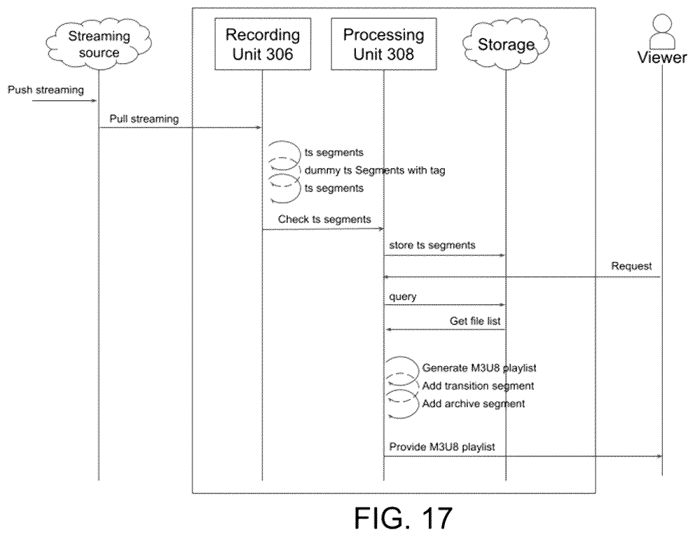

FIG. 17 is an exemplary sequence chart illustrating an operation of the configuration of the archive service according to some embodiments of subject application. As shown in FIG. 17, a streamer (not shown) may push the live streaming to a streaming source. In some embodiments, the streaming source may be a third-party service such as AWS or Wangsu, or be a service inside the live streaming server. The recording unit 306 may pull the live streaming for recording and archiving. In some embodiments, the recording unit 306 may record the live streaming as is segments. In some embodiments, if the recording unit 306 detects a specific portion SP in the live streaming, the recording unit 306 may dummy the ts segments with tags such as “discontinuity” or the like. Here, the tag of discontinuity may be referred to as a tag to show there is a specific portion SP in this ts segment. In some embodiments, the tag of discontinuity may be used by the processing unit 308 for the process of the archive contents. In some embodiments, the processing unit 308 may check if the ts segments are generated correctly. If the ts segments are generated correctly, the processing unit 308 may upload the ts segments to a storage.

In some embodiments, a viewer may require access to the archive contents. In response to the request, the processing unit 308 may query the archive contents and retrieve the file list from the storage. In some embodiments, the processing unit 308 may generate a M3U8 playlist. More specifically, the processing unit 308 may put the ts segments in order to generate the M3U8 playlist. In some embodiments, if the processing unit 308 detects some tags such as discontinuity tag in the ts segments, the processing unit 308 may perform a corresponding process on the ts segment. For example, if the recording unit 306 detects that a ts segment includes specific information such as PK mode or group call, the recording unit 306 may dummy the ts segment with a tag such as “discontinuity” or the like. The processing unit 308 may further process the ts segment according to the tag such as removing the ts segments, replacing the ts segments with transition segments, performing a process on the ts segments or the like. In some embodiments, the processing unit 308 may generate a M3U8 playlist accordingly and provide the M3U8 playlist to the viewer. Therefore, the viewer may replay the archive contents according to the M3U8 playlist.

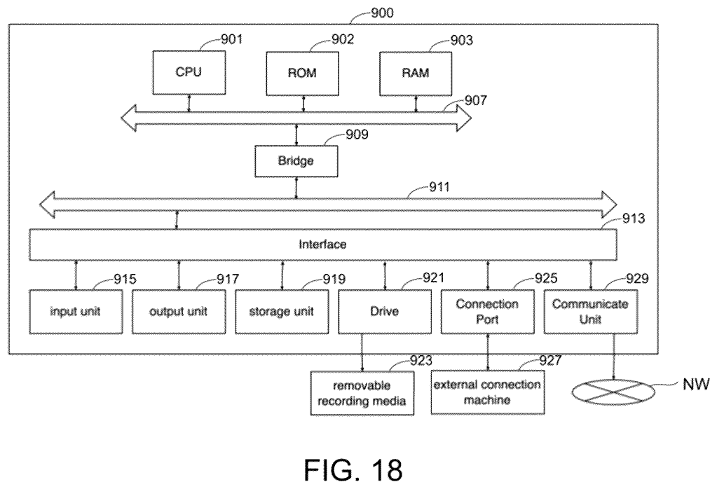

FIG. 18 is a schematic block diagram of computer hardware for carrying out a system configuration and processing according to some embodiments of subject application. The information processing device 900 in FIG. 18 is, for example, is configured to realize the server 10 and the user terminal 20, 30 and the archive service respectively according to some embodiments of subject application.

The information processing device 900 includes a CPU 901, read only memory (ROM) 903, and random-access memory (RAM) 905. In addition, the information processing device 900 may include a host bus 907, a bridge 909, an external bus 911, an interface 913, an input unit 915, an output unit 917, a storage unit 919, a drive 921, a connection port 925, and a communication unit 929. The information processing device 900 may include imaging devices (not shown) such as cameras or the like. The information processing device 900 may include a processing circuit such as a digital signal processor (DSP) or an application-specific integrated circuit (ASIC), instead of or in addition to the CPU 901.

The CPU 901 functions as an arithmetic processing device and a control device, and controls the overall operation or a part of the operation of the information processing device 900 according to various programs recorded in the ROM 903, the RAM 905, the storage unit 919, or a removable recording medium 923. For example, the CPU 901 controls overall operations of respective function units included in the server 10 and the user terminal 20 and of the above-described embodiment. The ROM 903 stores programs, operation parameters, and the like used by the CPU 901. The RAM 905 transiently stores programs used when the CPU 901 is executed, and parameters that change as appropriate when executing such programs. The CPU 901, the ROM 903, and the RAM 905 are connected with each other via the host bus 907 configured from an internal bus such as a CPU bus or the like. The host bus 907 is connected to the external bus 911 such as a Peripheral Component Interconnect/Interface (PCI) bus via the bridge 909.

The input unit 915 is a device operated by a user such as a mouse, a keyboard, a touchscreen, a button, a switch, and a lever. The input unit 915 may be a device that converts physical quantity to electrical signal such as audio sensor (such as microphone or the like), acceleration sensor, tilt sensor, infrared radiation sensor, depth sensor, temperature sensor, humidity sensor or the like. The input unit 915 may be a remote-control device that uses, for example, infrared radiation and another type of radio waves. Alternatively, the input unit 915 may be an external connection device 927 such as a mobile phone that corresponds to an operation of the information processing device 900. The input unit 915 includes an input control circuit that generates input signals on the basis of information which is input by a user to output the generated input signals to the CPU 901. The user inputs various types of data and indicates a processing operation to the information processing device 900 by operating the input unit 915.

The output unit 917 includes a device that can visually or audibly report acquired information to a user. The output unit 917 may be, for example, a display device such as an LCD, a PDP, and an OLED, an audio output device such as a speaker and a headphone, and a printer. The output unit 917 outputs a result obtained through a process performed by the information processing device 900, in the form of text or video such as an image, or sounds such as audio sounds.

The storage unit 919 is a device for data storage that is an example of a storage unit of the information processing device 900. The storage unit 919 includes, for example, a magnetic storage device such as a hard disk drive (HDD), a semiconductor storage device, an optical storage device, or a magneto-optical storage device. The storage unit 919 stores therein the programs and various data executed by the CPU 901, and various data acquired from an outside.

The drive 921 is a reader/writer for the removable recording medium 923 such as a magnetic disk, an optical disc, a magneto-optical disk, and a semiconductor memory, and built in or externally attached to the information processing device 900. The drive 921 reids out information recorded on the mounted removable recording medium 923, and outputs the information to the RAM 905. The drive 921 writes the record into the mounted removable recording medium 923.

The connection port 925 is a port used to directly connect devices to the information processing device 900. The connection port 925 may be a Universal Serial Bus (USB) port, an IEEE1394 port, or a Small Computer System Interface (SCSI) port, for example. The connection port 925 may also be an RS-232C port, an optical audio terminal, a High-Definition Multimedia interface (HDMI (registered trademark)) port, and so on. The connection of the external connection device 927 to the connection port 925 makes it possible to exchange various kinds of data between the information processing device 900 and the external connection device 927.

The communication unit 929 is a communication interface including, for example, a communication device for connection to a communication network NW. The communication unit 929 may be, for example, a wired or wireless local area network (LAN), Bluetooth (registered trademark), or a communication card for a wireless USB (WUSB).

The communication unit 929 may also be, for example, a router for optical communication, a router for asymmetric digital subscriber line (ADSL), or a modem for various types of communication. For example, the communication unit 929 transmits and receives signals on the Internet or transmits signals to and receives signals from another communication device by using a predetermined protocol such as TCP/IP. The communication network NW to which the communication unit 929 connects is a network established through wired or wireless connection. The communication network NW is, for example, the Internet, a home LAN, infrared communication, radio wave communication, or satellite communication.

The imaging device (not shown) is a device that images real space using an imaging device such as a charge coupled device (CCD) or a complementary metal oxide semiconductor (CMOS), for example, and various members such as a lens for controlling image formation of a subject image on the imaging device and generates a captured image. The imaging device may capture a still picture or may capture a movie.

The present disclosure of the live streaming system 1 and archive service has been described with reference to embodiments. The above-described embodiments have been described merely for illustrative purposes. Rather, it can be readily conceived by those skilled in the art that various modifications may be made in making various combinations of the above-described components or processes of the embodiments, which are also encompassed in the technical scope of the present disclosure.

The procedures described herein, particularly flowchart or those described with a flowchart, are susceptible of omission of part of the steps constituting the procedure, adding steps not explicitly included in the steps constituting the procedure, and/or reordering the steps. The procedure subjected to such omission, addition, or reordering is also included in the scope of the present disclosure unless diverged from the purport of the present disclosure.

In some embodiments, at least a part of the functions performed by the server or archive service may be performed by other than the server 10 or archive service, for example, being performed by the user terminal 20 or 30. In some embodiments, at least a part of the functions performed by the user terminal 20 or 30 may be performed by other than the user terminal 20 or 30, for example, being performed by the server 10 or archive service. In some embodiments, the rendering of the frame image may be performed by the user terminal of the viewer, the server, the user terminal of the streamer or the like.

Furthermore, the system and method described in the above embodiments may be provided with a computer-readable non-transitory storage device such as a solid state memory device, an optical disk storage device, or a magnetic disk storage device, or a computer program product or the like. Alternatively, the programs may be downloaded from a server via the Internet.

Although technical content and features of the present disclosure are described above, a person having common knowledge in the technical field of the present disclosure may still make many variations and modifications without disobeying the teaching and disclosure of the present disclosure. Therefore, the scope of the present disclosure is not limited to the embodiments that are already disclosed, but includes another variation and modification that do not disobey the present disclosure, and is the scope covered by the following patent application scope.

LIST OF REFERENCE NUMBERS

| | | | |
|---|---|---|---|
| 1 | Live streaming system | 10 | Server |
| 20 | User terminal | 100 | Streaming unit |
| 102 | Video control unit | 104 | Audio control |
| | | | unit |
| 106 | Distribution unit | 108 | UI control unit |
| 200 | Viewing unit | 202 | UI control unit |
| 204 | Rendering unit | 206 | Input unit |
| 30, 30a, 30b | User terminal | 302 | Providing unit |
| 304 | Relay unit | 306 | Recording unit |
| 308 | Processing unit | 312 | Transition Unit |
| 320 | Stream DB | 322 | Archive DB |
| 324 | Transition DB | 326 | AD DB |
| 350 | ML model | 600 | Screen |
| 602 | Screen | 610 | Screen |
| 612 | Information | 614 | Information |
| 616 | Information | 618 | List |
| 620 | Button object | 638 | Object |
| 900 | Information processing | 901 | CPU |
| | device | | |
| 903 | ROM | 905 | RAM |
| 907 | Host bus | 909 | Bridge |
| 911 | External bus | 913 | Interface |
| 915 | Input unit | 917 | Output unit |
| 919 | Storage unit | 921 | Drive |
| 923 | Removable recording | 925 | Connection port |
| | medium | | |
| 927 | External connection device | 929 | Communication |
| LS | Live streaming | LV | Streamer |
| NW | Network | SP | Specific portion |
| AU1, AU2 | Viewer | | |
| S302, S304, | Step | | |
| S306, S308, | Step | | |
| S312, S314 | Step | | |
| S316, S318 | Step | | |
| VD, VD1, VD2 | Video | | |

What is claimed is:

1. A method for handling streaming data for a live streaming, comprising:
recording the streaming data for the live streaming;
storing the streaming data as archive contents; and
adding a transition segment in the archive contents.

2. The method for handling streaming data for a live streaming according to claim 1, further comprising
obtaining a request for entering the live streaming;
providing with the archive contents when the streaming data for the live streaming is inaccessible.

3. The method for handling streaming data for a live streaming according to claim 1, wherein
the transition segment includes information related to the archive contents before or after the transition segment.

4. The method for handling streaming data for a live streaming according to claim 1, wherein
the transition segment is added upon a portion of the archive contents,
the transition segment includes information related to the portion of the archive contents.

5. The method for handling streaming data for a live streaming according to claim 4, wherein
the transition segment includes information for the viewer to get access to or skip the portion of the archive contents.

6. The method for handling streaming data for a live streaming according to claim 1, wherein
the transition segment replaces a portion of the archive contents,
duration of the transition segment is the same as or less than duration of the portion of the archive contents.

7. The method for handling streaming data for a live streaming according to claim 1, wherein
the transition segment includes information such as recommended streamers, advertisements, sales, news, questionnaires or the like.

8. The method for handling streaming data for a live streaming according to claim 1, wherein
recording the streaming data automatically or in response to an action from a user terminal of a streamer or a viewer.

9. A system for handling streaming data for a live streaming, comprising one or a plurality of processors, wherein the one or plurality of processors execute a machine-readable instruction to perform:
recording the streaming data for the live streaming;
storing the streaming data as archive contents; and
adding a transition segment in the archive contents.

10. A non-transitory computer-readable medium including program instructions, that when executed by one or more processors, cause the one or more processors to execute:
recording the streaming data for the live streaming;
storing the streaming data as archive contents; and
adding a transition segment in the archive contents.
